(19) United States
(12) Patent Application Publication
(10) Pub. No.: US 2022/0340188 A1
(43) Pub. Date: Oct. 27, 2022

(54) LOCKABLE WHEELS

(71) Applicant: HEWLETT-PACKARD DEVELOPMENT COMPANY, L.P., Spring, TX (US)

(72) Inventors: Huey-Min TZENG, Taipei City (TW); Tien Liang CHUNG, Taipei City (TW)

(21) Appl. No.: 17/240,771

(22) Filed: Apr. 26, 2021

(51) Int. Cl. B62B 5/04; B60B 35/00; B62B 3/00

(52) U.S. Cl. CPC B62B 5/0457; B60B 35/006; B62B 3/00; B62B 5/0404; B60T 1/005

(57) ABSTRACT

An example apparatus includes a base including a first locking surface, a wheel including an axle, and a locking body at the axle of the wheel to rotate with the wheel. The locking body includes a second locking surface to engage the first locking surface of the base to lock the wheel. The apparatus further includes a plate spring that captures the axle of the wheel to allow wheel to rotate. The plate spring urges the second locking surface of the locking body against the first locking surface of the base to lock the wheel. The plate spring is to deflect under application of an external force to separate the second locking surface of the locking body from the first locking surface of the base to allow the wheel to roll.

### BACKGROUND

Wheels are used on various apparatuses to provide movement and portability. A wheel may be locked to provide stability and may be unlocked to allow movement.

### BRIEF DESCRIPTION OF THE FIGURES

FIG. 1A is a perspective diagram of an example wheel apparatus that includes a supporting plate spring to deflect under an externally applied force to unlock the wheel.

FIG. 1B is an exploded perspective diagram of the example wheel apparatus of FIG. 1A.

FIG. 2A is a side view of the example wheel apparatus of FIG. 1A under an expected load that results in a locked configuration that inhibits rotation of the wheel.

FIG. 2B is a side view of the example wheel apparatus of FIG. 1A under a load that exceeds an expected load that results in a free configuration that allows rotation of the wheel.

FIG. 3 is a perspective diagram of an example computing device that includes a chassis and a plurality of lockable wheel apparatuses that are normally locked and that unlock under externally applied force.

FIG. 4A is a perspective diagram of an example wheel and axle for the example wheel apparatus of FIG. 1A.

FIG. 4B is a perspective diagram of the axle of FIG. 4A with the wheel removed.

FIG. 5 is a side view of an example wheel apparatus with a locking body of a different regular polygonal shape.

### DETAILED DESCRIPTION

Lockable wheels may be used to conveniently move and position computing equipment, such as desktop or gaming computer tower cases, which may be heavy and too cumbersome to move comfortably. For example, a computing device may be positioned at a location that is out of the way, such as under a desk, between pieces of furniture, adjacent a wall, etc., only to be brought out occasionally when access to the case is desired. Lockable wheels allow long-term stowage of computing devices in a way that preserves convenient access when desired. Moreover, lockable wheels reduce or eliminate the need to lift a computing device, which can allow for greater accessibility by a wide variety of users.

Wheel locking and unlocking is often achieved with a brake mechanism that includes several moving parts. Such mechanisms may be quite complex and have multiple points of failure. When multiple wheels are to be locked and unlocked, the user has to actuate each wheel's brake mechanism individually or additional linkage components are used to link the individual brake mechanisms. Such systems tend to be complex, cumbersome to use, and unreliable.

This disclosure provides examples of automatic locking wheels for a chassis or case of a computing device or similar container, in which a wheel normally locks by way of a coaxial locking body with flat surface (e.g., an octagonal plate) that abuts a flat surface of the chassis. When the case is depressed towards a surface on which the case is disposed, e.g., a person presses down on the case, the wheel deflects a plate spring or other deflectable member, which disengages the flat surfaces and allows the wheel to roll. The plate spring serves to both capture the wheel and engage/release the locking body. This mechanism has reduced complexity and fewer points of potential failure. In addition, multiple of such automatic locking wheels provided to the same chassis or container may be actuated simultaneously without additional linkage components.

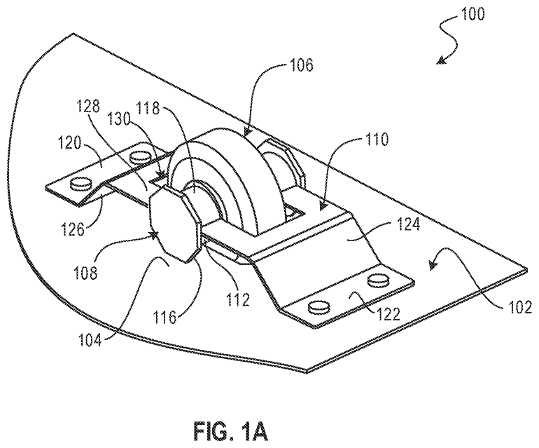

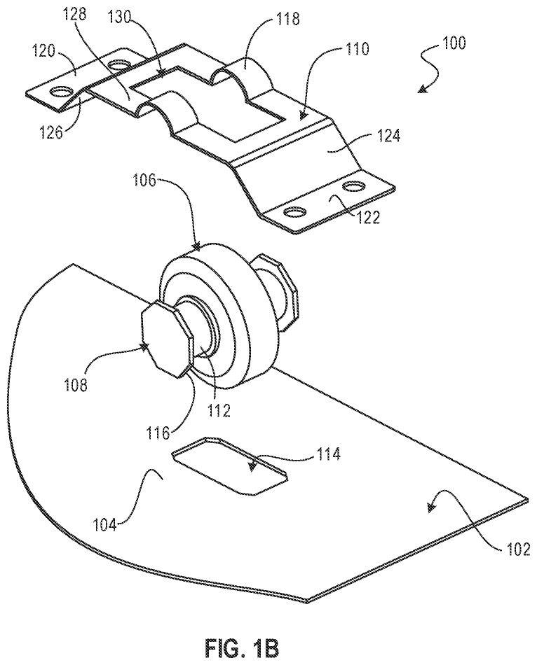

FIGS. 1A and 1B show an example wheel apparatus 100. The apparatus 100 may be used at the bottom of a chassis (also referred to as a case, housing, or tower) of a computing device, such as a desktop computer, an all-in-one (AIO) computer, or a server rack, among others. The apparatus 100 may be used on another object that is normally stationary but may be rolled from time to time, such as a container, or other types of electronic devices, e.g., imaging devices such as printers, copiers, or additive manufacturing devices (3D printers). A number of apparatuses 100 (e.g., three, four, etc.) may be located at different supporting locations at the bottom of the object. The wheel apparatus 100 is normally locked or locked by default, that is, locked absent an external force. When an external force is applied to the object (e.g., by a person pressing the object downwards), the wheel apparatus 100 unlocks to allow the object to be rolled.

The wheel apparatus 100 includes a base 102 that provides a first locking surface 104. The base 102 may be part of the chassis of a computing device, such as a bottom wall, or a wall or panel that is closest to or facing a surface on which the computing device is resting or disposed. The first locking surface 104 may be a flat surface or other feature that acts as a stop.

The wheel apparatus 100 further includes a wheel 106, a locking body 108, and a deflectable member, such as a plate spring 110. As discussed below, the plate spring 110 secures the wheel 106 to the base 102 and further provides for locking and unlocking of the wheel 106 with respect to the base 102 by the locking body 108.

The wheel 106 is generally cylindrical and includes a cylindrical central axle 112 about which the wheel 106 rotates. The wheel 106 rotates in unison with the axle 112, which may be rotatably held by the plate spring 110. The wheel 106 is of larger diameter than the axle 112 and protrudes from an opening 114, such as an opening in the bottom of the chassis or other object that is carried by the wheel apparatus 100, which in this example is an opening in the base 102. The wheel 106 may be formed monolithically with the axle 112 or may be a separate part that is attached to the axle 112.

The locking body 108 is disposed at the axle 112 of the wheel 106 and rotates in unison with the axle 112 and the wheel 106. The locking body 108 may be positioned at an end of the axle 112. The locking body 108 may be a plate or have a plate shape. The locking body 108 may be formed monolithically with the axle 112 or may be a separate part that is attached to the axle 112. Any number of locking bodies 108 may be provided. In the example depicted, two locking bodies 108 are provided, one at each distal end of the axle 112 on opposite sides of the wheel 106.

In this example, the wheel 106, axle 112, and locking body 108 are coaxial and rotate in unison.

The locking body 108 includes a second locking surface 116 to engage the first locking surface 104 of the base 102 to lock the wheel 106 against rotation. The first and second locking surfaces 104, 116 may be brought into mutual abutment or contact that restricts free rotation of the second locking surface 116 and thus restricts free rotation of the axle 112 and wheel 106. In the example depicted, the second locking surface 116 is a flat surface that abuts the flat first locking surface 104 to stop rotation of the axle 112 and wheel 106. In other examples, the first and second locking surfaces 104, 116 are provided with other complementary shapes, such as non-circular shapes, that provide locking contact or engagement.

The locking body 108 may include any suitable number of second locking surfaces 116 in any suitable arrangement that allows each second locking surface 116 to engage the first locking surface 104 of the base 102. The locking body 108 may be a plate-shaped body with a polygonal perimeter that provides the second locking surfaces 116. In the example depicted, eight second locking surfaces 116 are provided as the outside surfaces of a regular octagonal locking body 108.

The first and second locking surfaces 104, 116 are selectively engageable to lock and release the wheel 106 by way of the plate spring 110.

The plate spring 110 captures the axle 112 in a rotatable manner to allow the axle 112 and wheel 106 to rotate. In this example, the plate spring 110 includes an arcuate portion 118 complementary to the round shape of the axle 112. The arcuate portion 118 receives the round portion of the axle 112. The plate spring 110 may have ends 120, 122 affixed to the base 102. The arcuate portion may be positioned about midway between the ends 120, 122. The plate spring 110 may be considered a support bracket with ends 120, 122 attached to the base 102.

The plate spring 110 may further include bends 124, 126 to offset the arcuate portion 118 from the base 102 to provide space between the arcuate portion 118 and the base 102 to capture the axle 112.

The plate spring 110 may include a deflectable portion 128 between the ends 120, 122. The deflectable portion 128 may include a flat elongated portion, which may be made of thin metal or stiff plastic to provide a resilient spring force, which may result from elastic deformation of the deflectable portion 128 under external force and return to its initial shape after removal of external force.

The plate spring 110 may include a slot 130 to accommodate the wheel 106. The slot 130 may be bounded by two deflectable portions 128 on either side. The axle 112 may be captured by the plate spring 110 at two opposing sides of the slot 130, for example, by two arcuate or round portions 118.

The wheel 106, axle 112, and locking body 108 may be captured between the plate spring 110 and the base 102 by the constraints of the locking body 108 abutting the base 102 and the axle 112 abutting the arcuate portion 118 of the plate spring 110.

The wheel 106, axle 112, locking body 108, and plate spring 110 may be considered a lockable wheel assembly that is attachable to a base 102, such as a wall or other structure of a chassis or container, by the ends 120, 122 of the plate spring 110, which acts as a deflectable support bracket to carry the weight of chassis or container.

The plate spring 110 urges the second locking surface 116 of the locking body 108 against the first locking surface 104 of the base 102 to lock the wheel 106. Under application of an external force, the plate spring 110 deflects, which separates the second locking surface 116 of the locking body 108 from the first locking surface 104 of the base 102 to allow the wheel 106 to roll.

The number of second locking surfaces 116 may be selected as different from the examples discussed herein. The second locking surfaces 116 are arranged to be angularly separated from one another such that, at any given angular position of the wheel 106, the external force can be removed and there will be a second locking surface 116 sufficiently aligned with the first locking surface 104 to be able to lock the wheel 106. That is, at any given rotation of the locking body 108, a corner or edge that terminates a second locking surface 116 will be able to contact the first locking surface 104 to impart rotation to the locking body 108 to bring the second locking surface 116 into locking contact with the first locking surface 104. The larger the number of second locking surfaces, the higher the fidelity or precision with locking the chassis in its current location after movement.

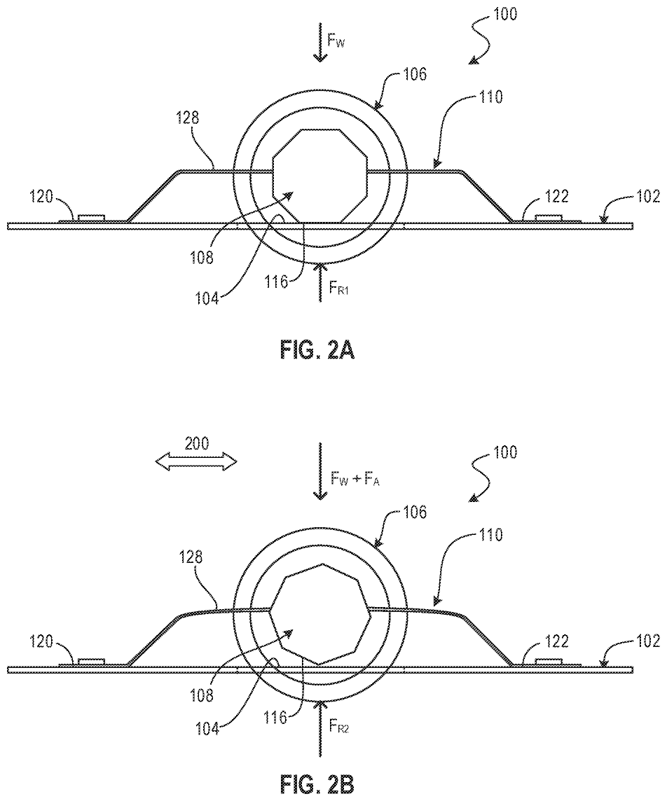

FIGS. 2A and 2B are side views showing operation of the wheel apparatus 100. FIG. 2A shows the wheel apparatus 100 under an expected load that results in a locked configuration that inhibits rotation of the wheel. FIG. 2B shows the wheel apparatus under a load that exceeds an expected load that results in a free configuration that allows rotation of the wheel

In FIG. 2A, the apparatus 100 is under an expected load, which includes weight of the chassis or housing and weight of the contents thereof, designated as F_{W}. The expected load F_{W} is transmitted from the chassis to the plate spring 110 via the ends 120, 122 of the plate spring 110, and transmitted by the plate spring 110 via contact with the axle 112 to the wheel 106, which receives a reaction F_{R1} from a surface on which the apparatus 100 rests. The spring force provided by the plate spring 110 urges the flat locking surface 116 of the locking body 108 into contact with the complementary flat locking surface 104 at the base 102, which may be the inside of the bottom of the chassis, so as to stop the wheel 106 from rotating. The locking body 108 is thus engaged with a stop, in the form of the locking surface 104 at the base 102, to inhibit rotation of the wheel 106. The expected load F_{W} is insufficient to deflect the plate spring 110 enough to separate the locking surface 116 of the locking body 108 from the locking surface 104 of the base 102 by an amount that would unlock the wheel 106. The addition of a relatively small applied external force may also be insufficient to separate the locking surface 116 of the locking body 108 from the locking surface 104 of the base 102 sufficiently to unlock the wheel 106. While some deflection of the plate spring 110 may occur under the expected load, F_{W}, the deflection is not enough to free the wheel 106.

As shown in FIG. 2B, when an applied external force, F_{A}, exceeds a certain amount, the total load, F_{W}+F_{A}, exceeds the expected load, F_{W}, to a degree that deflects the plate spring 100 against its spring force sufficiently to separate the flat surface 116 of the locking body 108 from the complementary flat surface 104 at the base 102, so as to free the wheel 106 to rotate. The increased total load disengages the locking body 108 from the stop provided by the base 102 to allow rotation of the wheel 106. In this configuration, the plate spring 110 hangs freely from the axle 112 of the wheel 106 by the arcuate portion 118 (FIG. 1A) and the wheel 106 receives a reaction F_{R2} from the supporting surface. The applied external force, F_{A}, may be provided by a person pressing downwards on a chassis or housing of a computing device, or by the weight of an object placed in or on the chassis or housing. The wheel 106 is free to roll and thus the chassis or other object to which the apparatus 100 is attached may be rolled, as shown by arrow 200.

When the applied external force, F_{A}, is removed, the apparatus 100 automatically returns to the locked state shown in FIG. 2A. If the locking surfaces 104, 116 are not aligned when the force is removed, the polygonal shape of the locking body 108 causes a small rotation to bring the locking surface 116 to rest against the locking surface 104 of the base 102. Hence, no separate action by the user is required to lock the apparatus at the destination location of the chassis or container.

The spring force provided by the plate spring 110 may be selected to support an expected range of loading or weight, F_{W}, while keeping the wheel locked, and further to release the brake under a desired range of applied force, F_{A}. A suitable spring force may be selected by the sizing, thickness, and/or material of the plate spring 110, as well as the shape of the deflectable portion 128 and bends 124, 126.

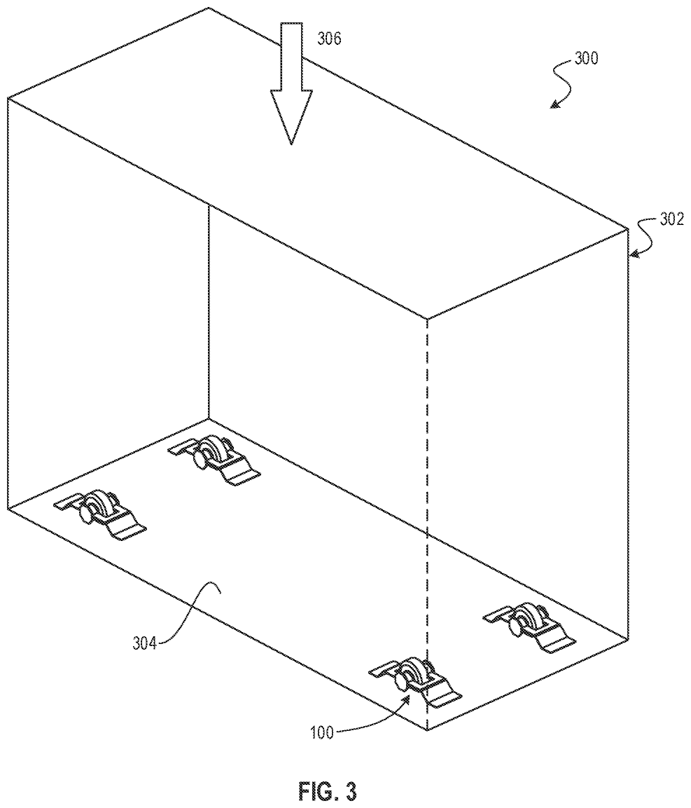

FIG. 3 shows an example computing device 300 that includes a chassis 302 and a plurality of lockable wheel apparatuses 100 attached to the bottom 304 of the chassis 302 to support the weight of the chassis 302 and contents. In this example, four lockable wheel apparatuses 100 are provided at four corners of the bottom 304 of the chassis 302. The lockable wheel apparatuses 100 may be configured to lock under a range of expected downward loads, such as a range of expected total weights of the chassis, mainboard, expansion cards, storage drives, and other expected components. The lockable wheel apparatuses 100 may be configured to release and provide free rolling under a range of loads that exceed the expected downward load, which may be provided by a person pressing down on the top of the chassis at 306. As such, rolling of the computing device 300 is normally inhibited. When the computing device 300 is to be moved, all of the lockable wheel apparatuses 100 provided to the computing device 300 may be released simultaneously by a single action without additional components.

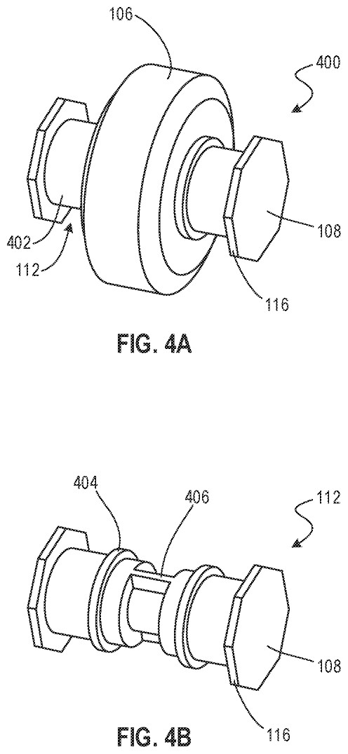

FIG. 4A shows an example lockable wheel assembly 400 that may be used with the apparatuses discussed herein. The lockable wheel assembly 400 includes a wheel body 106 mounted over an axle 112. The wheel body 106 may be made of rubber or resilient/soft plastic.

The axle 112 includes a round surface 402 to provide for rotation of the wheel assembly 400 and a flat surface 116 to provide for locking of the wheel assembly 400. The round surface 402 is sized to nest within an arcuate portion 118 (FIG. 1) of a deflectable member. Several flat surfaces 116 may be provided to a polygonal locking body 108 at each end of the axle 112. The axle 112 may be made of metal, rigid plastic, or other suitably stiff materials.

FIG. 4B shows the axle 112 with the wheel body 106 removed. As shown, the axle 112 may include circumferential ridges 404 on both sides of the wheel body 106 to keep the wheel body 106 in axial position on the axle 112. The axle 112 may further include a non-round portion 406 for contact with a complementary portion of the wheel body 106 to force the wheel body 106 and axle 112 to rotate in unison.

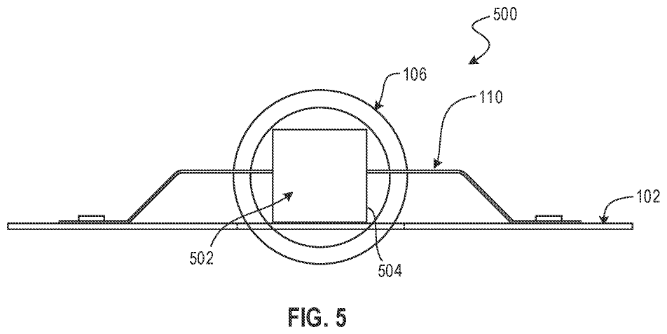

With reference to FIG. 5, another example lockable wheel apparatus 500 includes a locking body 502 with a square or rectangular shape. The locking body 502 provides four locking surfaces 504.

In other examples, any suitable shape of locking body with multiple locking surfaces may be provided. It should be recognized that fewer locking surfaces may provide for stronger locking effect, by way of larger locking surfaces, with the tradeoff of fewer angular increments at which to stop.

In view of the above it should be apparent that a lockable wheel apparatus may include a deflectable member that urges a locking body into contact with a stop, such as an inside surface of a container or chassis to which the lockable wheel apparatus is provided. A wheel may thus be normally locked. When an external force is provided, such as by a person's hand, the deflectable member deflects and separates the locking body from the stop to allow the wheel to rotate and the container or chassis to be rolled. Release of the external force locks the wheel again irrespective of its rotational position. The apparatus has reduced complexity by way of the deflectable member providing both support and locking/release action. In addition, multiple of such lockable wheel apparatuses may be simultaneously released and then relocked with a simple press-and-release action and without the need for linking mechanism.

It should be recognized that features and aspects of the various examples provided above can be combined into further examples that also fall within the scope of the present disclosure. In addition, the figures are not to scale and may have size and shape exaggerated for illustrative purposes.

1. An apparatus comprising:
a base including a first locking surface;
a wheel including an axle;
a locking body at the axle of the wheel to rotate with the wheel, the locking body including a second locking surface to engage the first locking surface of the base to lock the wheel; and
a plate spring that captures the axle of the wheel to allow wheel to rotate, wherein the plate spring urges the second locking surface of the locking body against the first locking surface of the base to lock the wheel, and wherein the plate spring is to deflect under application of an external force to separate the second locking surface of the locking body from the first locking surface of the base to allow the wheel to roll.

2. The apparatus of claim 1, wherein the plate spring includes an arcuate portion to receive the axle of the wheel.

3. The apparatus of claim 2, wherein the plate spring captures the axle of the wheel between the arcuate portion and the locking body when the external force is insufficient to separate the second locking surface of the locking body from the first locking surface of the base, and wherein the plate spring hangs from the axle of the wheel by the arcuate portion when the external force is sufficient to separate the second locking surface of the locking body from the first locking surface of the base.

4. The apparatus of claim 1, wherein the plate spring includes a slot to receive the wheel, and wherein the axle is captured by the plate spring at two opposing sides of the slot.

5. The apparatus of claim 1, wherein both ends of the plate spring are affixed to the base.

6. The apparatus of claim 1, wherein the locking body includes a polygonal plate.

7. The apparatus of claim 1, comprising two locking bodies at the axle on opposite sides of the wheel.

8. A computing device comprising:
a chassis; and
a lockable wheel attached to a bottom of the chassis to allow the chassis to roll, wherein the lockable wheel includes:
a wheel body;
an axle about which the wheel body is to rotate; and
a deflectable member that includes an arcuate portion to capture the axle to allow the wheel body to rotate;
wherein the axle includes a locking body that engages a stop at the chassis to inhibit rotation of the axle and the wheel body;
wherein the deflectable member is deflectable under an external force applied to the chassis to move the axle to disengage the locking body from the stop to allow rotation of the axle and the wheel body.

9. The computing device of claim 8, wherein the wheel body extends through an opening in the bottom of the chassis.

10. The computing device of claim 8, wherein the external force is downwards towards a surface on which the chassis is placed and supported by the lockable wheel.

11. The computing device of claim 8, wherein the deflectable member is affixed to the bottom of the chassis, and wherein the axle of the lockable wheel is positioned between the deflectable member and the bottom of the chassis.

12. The computing device of claim 8, wherein a weight of the chassis as supported by the axle and wheel body is carried by the deflectable member.

13. The computing device of claim 8, wherein the locking body includes a polygonal body, wherein the stop includes an inside surface of the chassis, and wherein a flat surface of the polygonal body abuts the inside surface of the chassis to inhibit rotation of the axle and the wheel body.

14. The computing device of claim 8, comprising a plurality of lockable wheels attached to the bottom of the chassis to support a weight of the chassis and contents thereof.

15. A container comprising:
a housing including a bottom that includes an opening therein; and
a wheel assembly including:
a wheel with an axle that includes a round surface and a flat surface, wherein the wheel is positioned to protrude from the opening in the bottom of the housing;
a support attached to the inside of the bottom of the housing to support the housing with the wheel, the support including a round portion to rotatably hold the round surface of the axle, the support providing a spring to constrain a position of the wheel with respect to the inside of the bottom of the housing, wherein the spring provides a spring force which:
under an expected load of the housing and contents thereof, the spring force urges the flat surface of the axle into contact with a complementary flat surface at the inside of the bottom of the housing to stop the wheel from rotating; and
under a load that exceeds the expected load, the flat surface of the axle separates from the complementary flat surface at the inside of the bottom of the housing, against the spring force, to free the wheel to rotate.

16. The container of claim 15, wherein the support includes a bracket with ends attached to the inside of the bottom of the housing, wherein the spring is provided by a deflectable portion of the bracket.

17. The container of claim 16, wherein the bracket includes two round portions to rotatably hold the round surface of the axle, and an opening between the two round portions to accommodate the wheel.

18. The container of claim 16, wherein the axle is captured between the bracket and the inside of the bottom of the housing.

19. The container of claim 15, wherein the axle includes a polygonal body that includes a plurality of flat surfaces to contact the complementary flat surface at the inside of the bottom of the housing to stop the wheel from rotating.

20. The container of claim 15, wherein the support includes a plate spring.
